(19) United States
(12) Patent Application Publication
(10) Pub. No.: US 2003/0156368 A1
(43) Pub. Date: Aug. 21, 2003

(54) In-rush current controller

(76) Inventor: Ricki D. Williams, Temecula, CA (US)

Correspondence Address: B. Noel Kivlin, Meyertons, Hood, Kivlin,, Kowert & Goetzel, P.C., P.O. Box 398, Austin, TX, 78767-0398, US

(21) Appl. No.: 10/002,776

(22) Filed: Nov. 2, 2001

(51) Int. Cl. H02H 9/00

(52) U.S. Cl. 361/58

(57) ABSTRACT

A method and apparatus are provided for controlling delivery of electrical power to a hot swappable device. In a system that accepts hot swappable devices, a sensing circuit is provided to detect the hot swappable device being inserted into the system. The sensing circuit provides a signal indicative of the hot swappable device being inserted and a controller blocks delivery of system voltage to the hot swappable device for a preselected duration of time.

### BACKGROUND OF THE INVENTION

1. Field of the Invention

This invention relates generally to hot swappable electronic devices, and, more particularly, to a method and apparatus for controlling in-rush current in a system that supports hot swappable devices.

2. Description of the Related Art

The last several years have witnessed an increased demand for network computing. Businesses typically rely on network computing to maintain a competitive advantage over other businesses. As such, developers, when designing processor-based systems for use in network-centric environments, consider several factors to meet the expectation of the customers. The factors may include, for example, functionality, reliability, scalability, configurability and performance of such systems.

One example of a processor-based system used in a network-centric environment is a mid-range server system. A single mid-range server system may have a plurality of system boards and devices that may, for example, be configured as one or more system domains, where a system domain, for example, may act as a separate machine by running its own instance of an operating system to perform one or more of the configured tasks.

The benefits of providing substantially independently operating system domains within an integrated system become readily apparent as customers are able to perform a variety of tasks that would otherwise be reserved for several different machines. This independence is further enhanced by an ability to dynamically reconfigure the system. In the field of computer systems, hot swappable devices have become increasingly commonplace, particularly in server systems. That is, in a typical server system, a number of devices and/or printed circuit boards may be installed and/or removed from the server without powering down the server. A server that may be dynamically reconfigured by the addition of a device and/or a printed circuit board produces numerous advantages, particularly with respect to the server system's ability to remain powered up and doing useful work for its many users even while the reconfiguration process is ongoing.

Installing a device and/or a printed circuit board into an operating computer system, however, can, in some cases, be problematic. For example, if electrical signals, such as electrical power, are present and active when the device and/or printed circuit board are installed, undesirable arcing may occur and damage sensitive electronic components located thereon. Additionally, the electronic components may be subjected to substantial stress as relatively large currents are delivered to the newly added device.

### SUMMARY OF THE INVENTION

In one aspect of the instant invention, a method is provided. The method is comprised of detecting a device being inserted in a system, and blocking delivery of an electrical signal to the inserted device for a first preselected duration of time.

In another aspect of the instant invention, an apparatus is provided. The apparatus is comprised of a printed circuit board, a sensing circuit and a controller. The sensing circuit detects a device being electrically coupled to the printed circuit board and provides a first signal indicative thereof. The controller is associated with the printed circuit board and receives the first signal and blocks delivery of electrical power to the device for a first preselected duration of time.

### BRIEF DESCRIPTION OF THE DRAWINGS

The invention may be understood by reference to the following description taken in conjunction with the accompanying drawings, in which like reference numerals identify like elements, and in which:

FIG. 1 shows a stylized block diagram of a system in accordance with one embodiment of the present invention;

FIG. 2 illustrates a stylized block diagram of a portion of the system of FIG. 1 responsible for controlling electrical power delivered to various devices and/or printed circuit boards in the system;

FIG. 3 illustrates a stylized diagram of one embodiment of a system for producing a signal indicative of the presence of a board in the system of FIGS. 1 and 2;

FIG. 4 illustrates a first embodiment of a stylized block diagram of a control logic and delay timer of FIG. 2;

FIG. 5 illustrates a second embodiment of a stylized block diagram of a control logic and delay timer of FIG. 2; and

FIG. 6 illustrates one embodiment of a stylized block diagram of an inrush controller of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

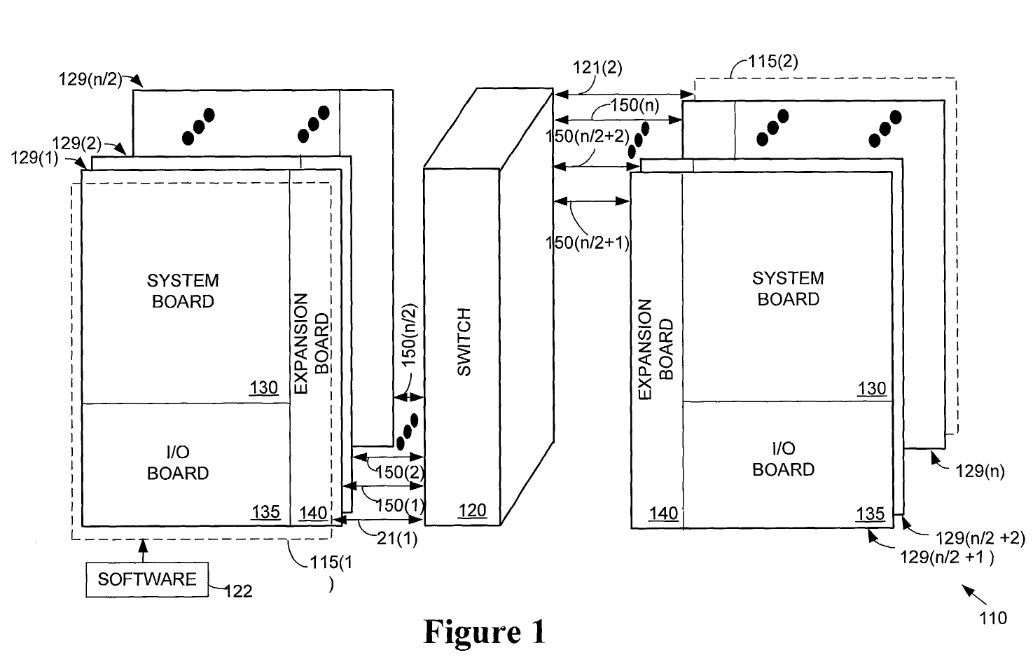

Referring now to FIG. 1, a block diagram of a system 110 in accordance with one embodiment of the present invention is illustrated. The system 110, in one embodiment, includes a plurality of system control boards 115(1-2) that are coupled to a switch 120. For illustrative purposes, lines 121(1-2) are utilized to show that the system control boards 115(1-2) are coupled to the switch 120, although it should be appreciated that, in other embodiments, the boards 115(1-2) may be coupled to the switch in any of a variety of ways, including by edge connectors, cables, or other available interfaces.

The system 110 includes a plurality of system board sets 129(1-n) that are coupled to the switch 120, as indicated by lines 150(1-n). The system board sets 129(1-n) may be coupled to the switch 120 in one of several ways, including edge connectors or other available interfaces. The switch 120 may serve as a communications conduit for the plurality of system board sets 129(1-n), half of which may be connected on one side of the switch 120 and the other half on the opposite side of the switch 120.

The switch 120, in one embodiment, may be a 18×18 crossbar switch that allows system board sets 129(1-n) and system control boards 115(1-2) to communicate, if desired. Thus, the switch 120 may allow the two system control boards 115(1-2) to communicate with each other or with other system board sets 129(1-n), as well as allow the system board sets 129(1-n) to communicate with each other.

The system board sets 129(1-n), in one embodiment, comprise one or more boards, including a system board 130, I/O board 135, and expansion board 140. The system board 130 may include processors, as well as memories, for executing, in one embodiment, applications, including portions of an operating system. The I/O board 135 may manage I/O cards, such as peripheral component interface cards and optical cards that are installed in the system 110. The expander board 140, in one embodiment, generally acts as a multiplexer (e.g., 2:1 multiplexer) to allow both the system and I/O boards 130, 135 to interface with the switch 120, which, in some instances, may have only one slot for interfacing with both boards 130, 135.

The system 110 may be configured in any of a wide variety of schemes. That is, the number of board sets 129(1-n) that are included in the system 110 may vary widely, falling somewhere in the range of 1-18 in the illustrated embodiment. Further, partial board set may also be present in the system 110. For example, the board set 129(1) may be comprised of only the I/O board 135 or only the system board 130. Moreover, the configuration may be altered while the system 110 is operating, as the system 110 is configured to allow the I/O boards 135 and/or the system boards 130 to be hot swapped. That is, various I/O boards 135 and/or system boards 130 may be added to or removed from the system 110 while the system 110 is operating.

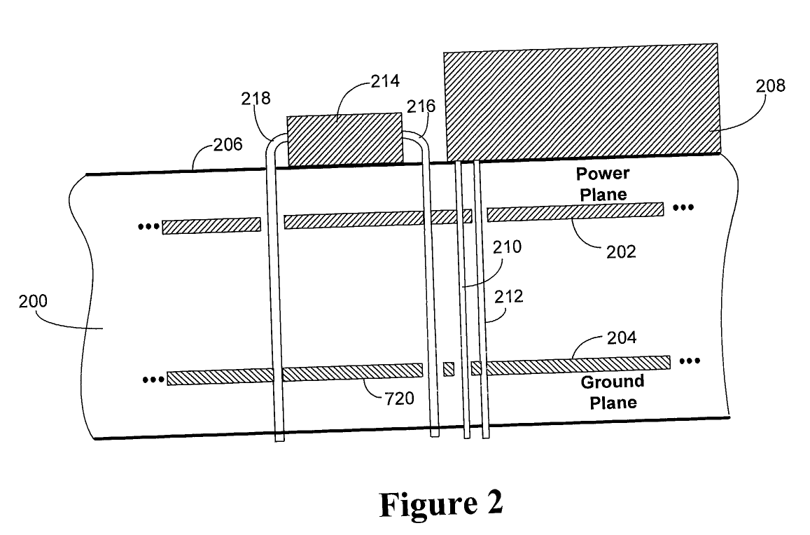

Turning now to FIG. 2, to reduce the likelihood of damage to the I/O boards 135 and/or the system boards 130 during hot swapping, a control logic and delay timer 200 is included to manage the delivery of electrical power to the I/O boards 135 and/or the system boards 130. Additionally, the control logic and delay timer 200 may also be configured to control delivery of electrical power to the expander board 140, as it is also hot swappable. In the illustrated embodiment, the control logic and delay timer 200 is physically located on the expander board 140; however, its physical location may be varied without departing from the scope of the instant invention. For example, the control logic and delay timer 200 may also be physically located on the switch 120 or the system control boards 115(1-2).

Generally, the control logic and delay timer 200 receives signals indicative of the presence of the system board 130, the I/O board 135, and the expander board 140 from board present circuitry 201, 203, 205 over lines 202, 204, 206, respectively. In response to detecting the presence of one of the boards 130, 135, 140, the control logic and delay timer 200 delivers a signal causing electrical power (e.g., 48V) to be delivered to the newly inserted board after a preselected duration of time (e.g., 7 seconds). System voltage is delivered over lines 230, 232 to the boards 130, 135, respectively. Additionally, the control logic and delay timer 200 may also control delivery of current to these boards 130, 135, 140. For example, the control logic and delay timer 200 may cause level of current delivered to the boards 130, 135 to be ramped up to its desired level over a preselected period of time.

The control logic and delay timer 200 is coupled to and controls a plurality of power supplies 208, 210, 212, 214, 216 through a plurality of inrush controllers 218, 220, 222, 224, 226, 228, 230. The power supplies 208, 210, 212, 214, 216 are configured to provide electrical power to various portions of the system 110, such as the boards 130, 135, 140. Additionally, the power supplies 208, 210, 212, 214, 216 may also be responsible for delivering a variety of voltage levels to select portions of the system 110, as needed. In the illustrated exemplary embodiment, the power supplies 208, 210, 212, 214, 216 are responsible for delivering a supply voltage of about 48V to the boards 130, 135, 140. Generally, the control logic and delay timer 200 provides control signals to the inrush controllers 218, 220, 222, 224, 226, 228, 230, which respond to the control signals by delivering the supply voltage to their respective power supplies 208, 210, 212, 214, 216.

Generally, while a plurality of inrush controllers 218, 220, 222, 224, 226, 228, 230 and power supplies 208, 210, 212, 214, 216 are shown, they are substantially similar in configuration. Thus, only one exemplary inrush controller and power supply will be discussed in detail herein so as to avoid unnecessarily obscuring the instant invention. Similarly, the board present circuits 201, 203, 205 are substantially similar in configuration to one another, and thus only one exemplary board present circuit will be discussed in detail herein so as to avoid unnecessarily obscuring the instant invention.

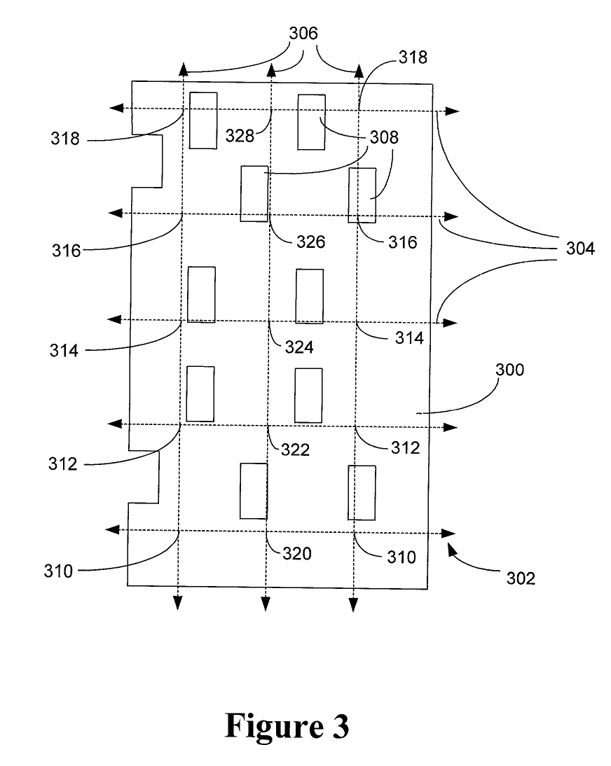

An exemplary configuration for producing and delivering the board present signal is illustrated in FIG. 3. The boards 130, 140 each respectively include a conventional edge connector 300, 302 with a plurality of electrically conductive pads 304 positioned thereon. The board present circuit 201 on the board 130 is comprised of an electrically conductive line 305, such as a lead line, wire, trace, etc. coupled between one of the pads 304 on the edge connector 300 and electrical ground. A corresponding pad 304 on the edge connector 300 of the board 140 is coupled through an electrically conductive line 306, such as a lead line, wire, trace, etc. to an input terminal of the control logic and delay timer 200. A pull-up resistor 308 is coupled between the line 306 and a voltage supply V_{cc}. When the board 130 is installed in the system 110, the pads 304 are electrically coupled together via a conventional edge connector stylistically represented by the line 204.

Thus, when the board 130 is not installed in the system 110, the pull-up resistor 308 places a voltage level of about V_{cc} onto the line 306, insuring that a logically high signal is delivered to the control logic and delay timer 200. On the other hand, when the board 130 is installed in the system 110, the line 306 is coupled through the line 204 and lead 305 to electrical ground, insuring that a logically low signal is delivered to the control logic and delay timer 200. This logically low signal serves as an indication to the control logic and delay timer 200 that the board 130 has been installed in the system 110.

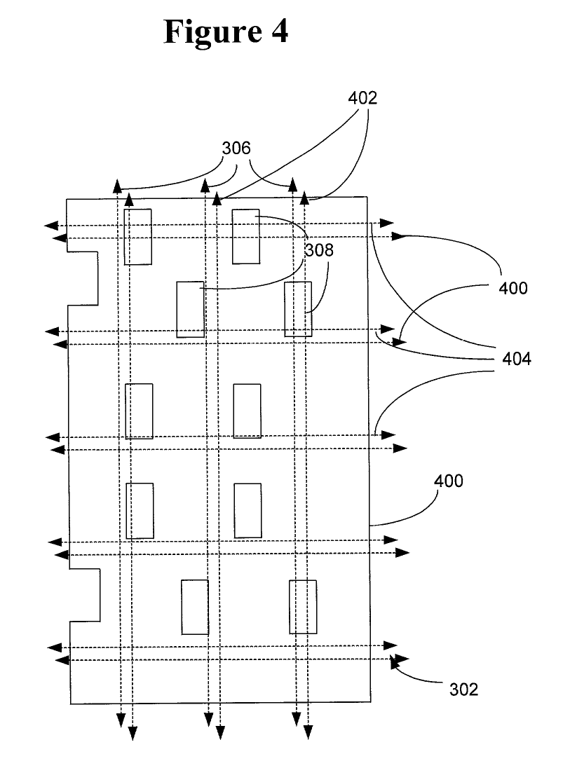

Turning now to FIG. 4, a block diagram of one embodiment of the control logic and delay timer 200 that is capable of performing at least some of the functions attributed to the control logic and delay timer 200 is illustrated. Generally, the control logic and delay timer 200 includes a timer 400 configured to receive the board present signal over the line 306. The timer 400 begins timing a preselected delay (e.g., 7 seconds) in response to receiving the logically low signal over the lead 306, indicating that the board 130 has been inserted into the system 110. After the preselected delay has expired, the timer 400 delivers a signal indicating that electrical power may now be delivered to the newly inserted board 130. If, however, the system 110 has detected a fault such that powering up the newly inserted board 130 may not be advisable, fault logic 402 will intercept the signal from the timer 400 and block the signal to prevent electrical power from being supplied to the newly inserted board 130. The fault logic 402 may be activated by any of a variety of fault conditions, such as a component failure, which may include a decoupling capacitor shorting out. Similarly, failure of a transistor or transformer in the input circuitry of a dc to dc power supply may cause the fault logic to block the signal to prevent electrical power from being supplied to the newly inserted board 130. Detection of the fault may be communicated to the fault logic 402 over a conventional communications link 404, such as a link using I²C protocol.

The communications link 404 may also be coupled to a manual operation circuit 406. The manual operation circuit 406 may be used to override the fault logic 402 to provide electrical power to the board 130 despite the presence of an otherwise disabling fault. For example, an operator may use a console (not shown) coupled to the system control board 115(1) to enter commands that are communicated over the communications link 404 to the manual operation circuit 406. In this manner, an operator may at least temporarily override a fault condition, or the operator may manually reset the fault logic 402 after the condition has been cured so that the board 130 may be powered up.

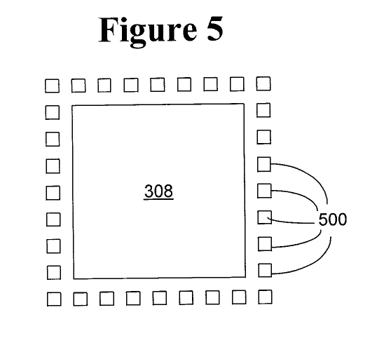

Turning now to FIG. 5, a block diagram of an alternative embodiment of a control logic and delay timer 500 that is capable of performing at least some of the functions attributed to the control logic and delay timer 500 is illustrated. Generally, the control logic and delay timer 500 operates substantially similar to the control logic and delay timer 200 discussed above, but differs primarily by the presence of a second timer 502, which, like the timer 400, is also configured to receive the board present signal over the line 306 and, after a preselected delay, produce a signal indicating that power should be delivered to the newly added board. The second timer 502 may be used to control delivery of a second supply voltage to the newly inserted board, or at least to introduce the supply voltage at a different time relative to the first timer 400. For example, the first timer 400 may be configured to control delivery of a supply voltage that is used to power a first portion of the components located on the newly added board, whereas the second timer 502 may be configured to control delivery of a supply voltage to a second portion of the components located on the newly added board. In some systems, it may be useful to allow a first portion of the circuitry located on the newly inserted board to begin operation before a second portion of the circuitry. For example, in one embodiment it has been useful to allow electrical power to be delivered to power management circuitry after a first, shorter preselected duration of time (e.g., 5 seconds), and to allow electrical power to be delivered to power management circuitry after a second, longer preselected duration of time (e.g., 7 seconds).

While the timers 400, 502 are illustrated as being separate devices, those skilled in the art will appreciate that the timers 400, 502 could be implemented in a single device. For example, if the timer is implemented using a counter, separate output terminals of the counter will produce a signal at different relative times.

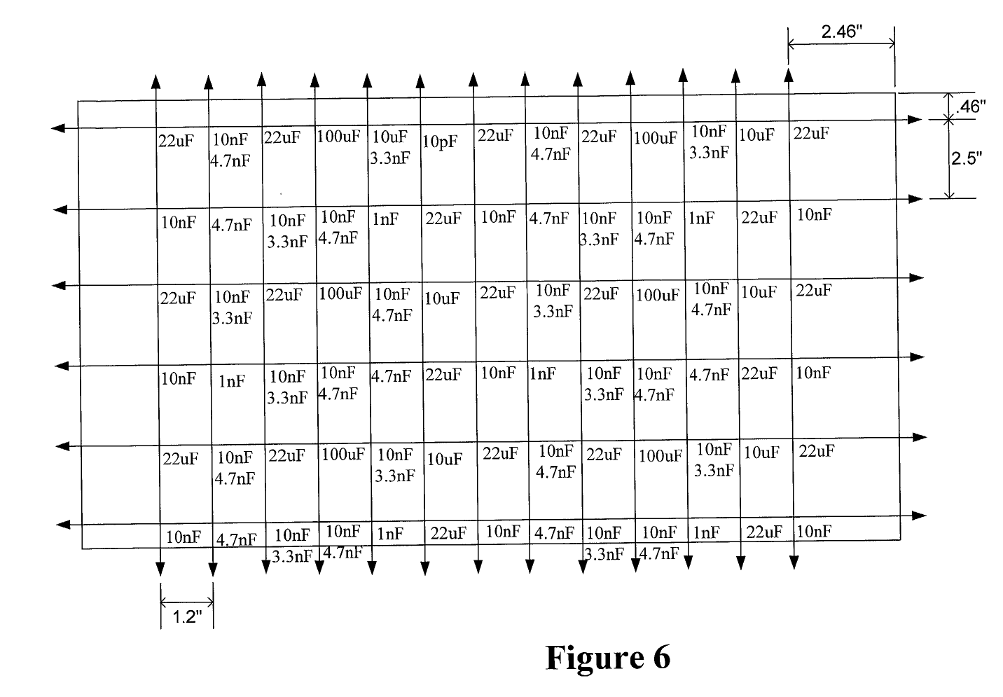

Turning now to FIG. 6, a block diagram of one embodiment of the inrush controller 222 is illustrated. Generally, the inrush controller 222 monitors current flowing to the board 130 and, at least initially, limits the rate at which the current is allowed to increase. The inrush current controller 222 includes a current sensor 602, which may take the form of a resistor, a hall effect device, or the like. A controllable element 604, such as a transistor, thyristor, or the like, is positioned in the line 230 to controllably block current from flowing therethrough. That is, a controller 600 receives a signal from the control logic and delay timer 200, indicating that the desired period of time has expired since the board 130 was inserted into the system. The controller 600 responds to this signal by enabling the control element 604 to begin passing current to the board 130.

The current flowing to the board 130 passes through the current sensor 602, which delivers a signal indicative of the magnitude of the current to the controller 600. The controller 600 analyzes the magnitude of the sensed current and then adjusts the level of energization being delivered to the controllable element 604 so as to modify the magnitude of the current passed to the board 130. Those skilled in the art will appreciate that the process of adjusting the level of energization of the controllable element may be accomplished in a variety of ways, such as pulse width modulation, varying the duty cycle, varying the voltage level of the excitation signal, and the like.

Using this feedback arrangement, the inrush controller 222 may reduce the occurrence of sudden, large currents being delivered to the newly added board 130. In one embodiment, the controller 600 allows the magnitude of the current being delivered to the board 130 to ramp up over time. For example, the current is allowed to linearly ramp from 0A to 10A at a rate of about 1A/10 microsecond.

In the embodiment illustrated in FIG. 2, the board 130 is illustrated with its two inrush controllers 224 connected to the output of the inrush controller 222. Thus, the inrush controller 222 operates as described above to prevent arcing and sudden, large inrush currents when the board 130 is inserted in the system 110. The inrush controllers 224, 226 are useful in applications where multiple relatively independent systems are present on the board 130, or where redundant power supplies are present. For example, on the board 130 the two power supplies 212, 214 may be coupled in parallel to provide redundant sources of power to the components located thereon. If one of the power supplies 212, 214 fails, its corresponding inrush controller 224, 226 may shut down the failing power supply, but the board 130 may continue to operate using the remaining power supply. Similarly, where the power supplies 212, 214 are providing power to relatively independent portions of circuitry on the board 130, a failing power supply may be detected and shut down. The associated circuitry will also be shut down. The other power supply continues to deliver power to the remaining portion of the circuitry, allowing it to continue with normal operation, or, in some cases, to take over at least some of the functions previously performed by some of the now disabled circuitry. In either case, the board 130 can “ride out” the failure without interrupting the operation of the system 110.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A system, comprising:
means for detecting a device being inserted into the system;
means for blocking delivery of an electrical signal to the inserted device for a first preselected duration of time.

2. The system of claim 1, wherein the means for blocking further comprises means for preventing delivery of electrical power to the inserted device for a first preselected duration of time.

3. The system of claim 2, wherein the means for blocking further comprises means for passing at least a portion of the electrical power to the inserted device after the first preselected duration of time.

4. The system of claim 2, wherein the means for blocking further comprises means for progressively increasing the level of current delivered to the inserted device after the first preselected duration of time.

5. The system of claim 1, wherein the means for blocking further comprises means for blocking a first electrical signal from being delivered to a first portion of the inserted device for a first preselected duration of time, and for blocking a second electrical signal from being delivered to a second portion of the inserted device for a second preselected duration of time, wherein the first preselected duration of time is greater than the second preselected duration of time.

6. The system of claim 1, wherein the means for blocking further comprises means for blocking electrical power from being delivered to a first portion of the inserted device for a first preselected duration of time, and for blocking electrical power from being delivered to a second portion of the inserted device for a second preselected duration of time, wherein the first preselected duration of time is greater than the second preselected duration of time.

7. A method, comprising:
detecting a device being inserted in a system; and
blocking delivery of an electrical signal to the inserted device for a first preselected duration of time.

8. The method of claim 7, wherein blocking delivery of an electrical signal further comprises preventing delivery of electrical power to the inserted device for a first preselected duration of time.

9. The method of claim 8, wherein blocking delivery of an electrical signal further comprises passing at least a portion of the electrical power to the inserted device after the first preselected duration of time.

10. The method of claim 8, wherein blocking delivery of an electrical signal further comprises progressively increasing the level of current delivered to the inserted device after the first preselected duration of time.

11. The method of claim 7, wherein blocking delivery of an electrical signal further comprises blocking a first electrical signal from being delivered to a first portion of the inserted device for a first preselected duration of time, and for blocking a second electrical signal from being delivered to a second portion of the inserted device for a second preselected duration of time, wherein the first preselected duration of time is greater than the second preselected duration of time.

12. The method of claim 7, wherein blocking delivery of an electrical signal further comprises blocking electrical power from being delivered to a first portion of the inserted device for a first preselected duration of time, and blocking electrical power from being delivered to a second portion of the inserted device for a second preselected duration of time, wherein the first preselected duration of time is greater than the second preselected duration of time.

13. A system, comprising:
a sensor adapted to detect a device being inserted into the system;
a controller adapted to block delivery of an electrical signal to the inserted device for a first preselected duration of time.

14. The system of claim 13, wherein the controller blocks delivery of electrical power to the inserted device for a first preselected duration of time.

15. The system of claim 14, wherein the controller passes at least a portion of the electrical power to the inserted device after the first preselected duration of time.

16. The system of claim 14, wherein the controller progressively increases the level of current delivered to the inserted device after the first preselected duration of time.

17. The system of claim 13, wherein the controller blocks a first electrical signal from being delivered to a first portion of the inserted device for a first preselected duration of time, and for blocking a second electrical signal from being delivered to a second portion of the inserted device for a second preselected duration of time, wherein the first preselected duration of time is greater than the second preselected duration of time.

18. The system of claim 13, wherein the controller blocks electrical power from being delivered to a first portion of the inserted device for a first preselected duration of time, and blocks electrical power from being delivered to a second portion of the inserted device for a second preselected duration of time, wherein the first preselected duration of time is greater than the second preselected duration of time.

19. An apparatus, comprising:
a printed circuit board;
a sensing circuit adapted to detect a device being electrically coupled to the printed circuit board and provide a first signal indicative thereof;
a controller associated with the printed circuit board, the controller being adapted to receive the first signal and block delivery of electrical power to the device for a first preselected duration of time.

20. A system, comprising:
a sensor adapted to detect a hot swappable device being inserted into the system;
a controller adapted to block delivery of system voltage to the hot swappable device for a first preselected duration of time.

21. An apparatus, comprising:
a printed circuit board having a connector adapted to receive a device therein;
a sensing circuit adapted to detect the device being coupled to the connector and provide a first signal indicative thereof;
a controller associated with the printed circuit board, the controller being adapted to deliver electrical power to the connector a preselected duration of time after receiving the signal from the sensing circuit.
